(19) United States
(12) Patent Application Publication
(10) Pub. No.: US 2010/0019581 A1
(43) Pub. Date: Jan. 28, 2010

(54) METHOD FOR CONTROLLING AN ELECTROMAGNET

(75) Inventors: Michael Pantke, Friedrichshafen (DE); Marc Abele, Friedrichshafen (DE)

Correspondence Address: DAVIS & BUJOLD, P.L.L.C., 112 PLEASANT STREET, CONCORD, NH, 03301, US

(73) Assignee: ZF Friedrichshafen AG, Friedrichshafen (DE)

(21) Appl. No.: 12/508,150

(22) Filed: Jul. 23, 2009

(30) Foreign Application Priority Data
Jul. 24, 2008 (DE) 10 2008 040 668.6

(51) Int. Cl. H01F 27/42

(52) U.S. Cl. 307/104

(57) ABSTRACT

A method of controlling magnetic flux through an electromagnet, the magnetic force of the electromagnet or the relative position between the yoke and the armature of the electromagnet, such that from an electric voltage applied across an induction coil of the electromagnet and determined by an appropriate measurement method, and from an electric current flowing through the induction coil and also determined by an appropriate measurement method, an actual value of the magnetic flux, the magnetic force or the relative position is calculated. The determined actual value is compared with a specified nominal value and as a function of the difference between the actual and the nominal values, the voltage applied across the induction coil and/or the current flowing through the induction coil is/are adapted such that the actual magnetic flux or magnetic force or relative position value approaches the related nominal value.

This applications claims priority from German patent application serial no. 10 2008 040 668.6 filed Jul. 24, 2008.

### FIELD OF THE INVENTION

The invention concerns a method for controlling an electromagnet.

### BACKGROUND OF THE INVENTION

In the context of the present invention, an electromagnet to be controlled comprises a yoke and an armature, with an induction coil associated with the yoke in order to induce a magnetic flux in the electromagnet. By virtue of the magnetic flux, a magnetic force can be exerted on the armature of the electromagnet, for example so as to attract the armature more strongly or less so and thereby establish a relative position between the armature and the yoke. In practice, the procedure for controlling an electromagnet of this type is that with the help of a separate sensor, for example a Hall sensor or a measurement coil, an actual value of the magnetic flux through the electromagnet is determined. This actual value determined with the help of the separate sensor is compared with a nominal value, and if a difference is found between the actual and the nominal values, the electromagnet is adjusted on the basis of the difference so as to bring the actual value closer to the nominal value. The use of separate sensors, however, add complexity and is expensive. A method for controlling an electromagnet is therefore needed, which does not require additional sensors.

Starting from that situation, the present invention addresses the problem of providing a new type of method for controlling an electromagnet.

### SUMMARY OF THE INVENTION

According to a first aspect of the invention, this problem is solved by a method for regulating the magnetic flux through an electromagnet. In this case, from an electric voltage applied to an induction coil and determined by an appropriate measurement method, and from an electric current flowing through the induction coil and also determined by an appropriate measurement method, an actual value of the magnetic flux is calculated, the actual value so determined is compared with a predetermined nominal value, and as a function of the difference between the actual and nominal values, the voltage applied to the induction coil and/or the electric current flowing through the induction coil is/are adapted so as to bring the actual value of the magnetic flux closer to its nominal value.

According to a second aspect of the invention, the problem is solved by a method for regulating the magnetic force of an electromagnet. In this case, from an electric voltage applied to an induction coil and determined by an appropriate measurement method, and from an electric current flowing through the induction coil and also determined by an appropriate measurement method, an actual value of the magnetic force is calculated, the actual value so determined is compared with a predetermined nominal value, and as a function of the difference between the actual and nominal values, the voltage applied to the induction coil and/or the electric current flowing through the induction coil is/are adapted so as to bring the actual value of the magnetic force closer to its nominal value.

According to a third aspect of the invention, the problem is solved by a method for regulating the relative position between the yoke and the armature of the electromagnet. In this case, from an electric voltage applied to an induction coil and determined by an appropriate measurement method, and from an electric current flowing through the induction coil and also determined by an appropriate measurement method, an actual value of the relative position calculated, the actual value so determined is compared with a predetermined nominal value, and as a function of the difference between the said actual and nominal values, the voltage applied to the induction coil and/or the electric current flowing through the induction coil is/are adapted so as to bring the actual value of the relative position closer to its nominal value.

In all the methods according to the invention, the electromagnet is regulated without the use of additional sensors. By measuring the current flowing through the induction coil and the voltage applied to the induction coil, an actual value of the magnetic flux and/or of the magnetic force and/or of the relative position between the yoke and the armature of the electromagnet can be determined. Since the determination of this actual value does not involve the use of additional sensors, complexity and costs can be reduced. Furthermore, the number of possible sources of error is reduced.

### BRIEF DESCRIPTION OF THE DRAWING

Preferred further developments of the invention emerge from the subordinate claims and the description presented below. Example embodiments of the invention, to which it is not limited, are explained in greater detail with reference to the drawing, which shows:

FIG. 1: Block circuit diagram to clarify the methods according to the invention for controlling an electromagnet.

### DETAILED DESCRIPTION OF THE PREFERRED EMBODIMENTS

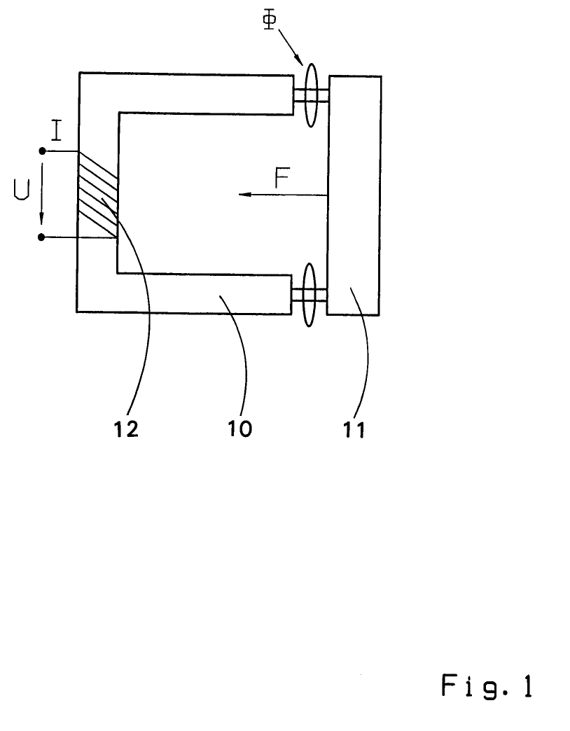

The invention concerns a method for controlling an electromagnet, such that as shown in FIG. 1 the electromagnet to be regulated comprises a yoke 10 and an armature 11. Associated with the yoke 10 is an induction coil 12, an electric voltage U being applied across the induction coil 12, by virtue of which an electric current i flows through the induction coil 12. The induction coil 12 has a number w of turns.

Since the induction coil 12 is carrying an electric current i, a magnetic flux φ is induced in the electromagnet, namely in its yoke 10, due to which a magnetic force F can be exerted on the armature 11 in order to establish a relative position between the yoke 10 and armature 11.

To control such an electromagnet, in the sense of the present invention it is proposed that from the electric voltage U and from the electric current i flowing through the induction coil and also determined by an appropriate measurement method, an actual value of the magnetic flux is calculated. In this case the magnetic flux is calculated in accordance with the following equation:

$$Φ = \frac{1}{w} * \int ( U - i * R ) d t$$

where φ is the magnetic flux, U is the electric voltage applied to the induction coil and determined by an appropriate measurement method, i is the electric current flowing through the induction coil and also determined by an appropriate measurement method, R is the predetermined electrical resistance of the electromagnet, and w is the predetermined number of turns of the induction coil.

The actual value of the magnetic flux determined from the above equation is then compared with a specified nominal value, and as a function of the difference between the actual and nominal values the voltage U applied across the induction coil, and hence the electric current i flowing through the induction coil are adapted in such manner that the actual value of the magnetic flux approaches its nominal value.

From the above, computationally determined actual value of the magnetic flux, the magnetic force acting on the armature 11 can be calculated using the following equation:

$$F = \frac{1}{2 * {μ}_{0} * A} * {Φ}^{2}$$

where F is the magnetic force, μ₀ is the specified permeability of vacuum, and A is the predetermined active attraction force area of the electromagnet.

From the above formula, in addition or alternatively to the actual value of the magnetic flux an actual value for the magnetic force can be calculated, so as then to compare the actual magnetic force value with a corresponding, specified nominal value and, as a function of a difference between the actual and nominal values, to adapt the voltage U applied across the induction coil 12, and hence the electric current i flowing through the induction coil in such manner that the actual value of the magnetic force approaches its nominal value.

According to an advantageous further development, from the actual value of the magnetic flux or from the actual value of the magnetic force an actual value of a relative position between the yoke 10 and the armature 11 of the electromagnet can be calculated. For this, the actual value of the relative position as a function of the actual value of the magnetic flux or of the magnetic force is determined from a characteristic performance curve of the electromagnet. The actual value so determined is then again compared with a corresponding nominal value, and as a function of the difference between the actual and nominal values the voltage U applied across the induction coil 12, and hence the electric current i flowing through the induction coil are adapted in such manner that the actual value of the relative position approaches its nominal value.

With the method according to the invention, various control parameters of an electromagnet can accordingly be adjusted, namely the magnetic flux and/or the magnetic force and/or the relative position between the yoke and the armature of the electromagnet.

The method according to the invention can be applied without any additional sensors, and thus allows an electromagnet to be controlled in a simple and inexpensive manner.

### INDEXES

10 Yoke
11 Armature
12 Induction coil

1-10. (canceled)

11. A method of controlling magnetic flux through an electromagnet, the method comprising the steps of:
calculating an actual value of the magnetic flux from an electric voltage applied to an induction coil and determined by an appropriate measurement method, and from an electric current flowing through the induction coil and also determined by an appropriate measurement method;
comparing the calculated actual value of the magnetic flux with a predetermined nominal value; and
adapting at least one of the electric voltage, applied to the induction coil, and the electric current flowing through the induction coil, as a function of a difference between the calculated actual value and the predetermined nominal value of the magnetic flux, to bring the actual value of the magnetic flux closer to the nominal value.

12. The method according to claim 11, further comprising the step of determining the actual value of the magnetic flux using the following equation:
$$Φ = \frac{1}{w} * \int ( U - i * R ) d t$$
where φ is the magnetic flux,
U is the electric voltage applied to the induction coil,
I is the electric current flowing through the induction coil, and
R and w are predetermined characteristic parameters.

13. The method according to claim 11, further comprising the step of calculating an actual value of a magnetic force from the actual value of the magnetic flux,
comparing the actual value with a predetermined nominal value, and
as a function of the difference between the said actual and nominal values, adapting at least one of the voltage applied to the induction coil and the electric current flowing through the induction coil to bring the actual value of the magnetic force closer to the nominal value of the magnetic force.

14. The method according to claim 13, further comprising the step of calculating the actual value of the magnetic force using the following equation:
$$F = \frac{1}{2 * {μ}_{0} * A} * {Φ}^{2}$$
where F is the magnetic force,
φ is the magnetic flux, and
μ₀ and A are predetermined parameters.

15. The method according to claim 11, further comprising the step of determining an actual value of a relative position between the yoke and the armature of the electromagnet from the actual value of either the magnetic flux or the magnetic force and the determined actual value of the relative position is compared with a predetermined nominal value, and
adapting at least one of the voltage applied to the induction coil and the electric current flowing through the induction coil as a function of the difference between the actual and nominal values to bring the actual value of the relative position closer to the nominal value of the relative position.

16. The method according to claim 15, further comprising the step of determining the actual value of the relative position from a characteristic performance curve of the electromagnet.

17. A method of controlling magnetic force of an electromagnet, the method comprising the steps of:
calculating an actual value of the magnetic force from an electric voltage applied to an induction coil and determined by an appropriate measurement method, and from an electric current flowing through the induction coil and also determined by an appropriate measurement method;
comparing the determined actual value with a predetermined nominal value; and
adapting the voltage applied to at least one of the induction coil and the electric current flowing through the induction coil as a function of a difference between the actual value and nominal value of the magnetic force to bring the actual value of the magnetic force closer to the nominal value of the magnetic force.

18. The method according to claim 17, further comprising the step of determining the actual value of the magnetic force using the following equations:
$$F = \frac{1}{2 * {μ}_{0} * A} * {Φ}^{2}$$
$$Φ = \frac{1}{w} * \int ( U - i * R ) d t$$
where F is the magnetic force,
φ is the magnetic flux,
U is the voltage applied across the induction coil,
I is the current flowing through the induction coil,
R is the predetermined electrical resistance of the electromagnet,
μ₀ is the specified permeability of vacuum,
A is the predetermined effective attraction force area of the electromagnet, and
w is the predetermined number of turns of the induction coil.

19. A method for controlling a relative position between the yoke and the armature of an electromagnet, the method comprising the steps of:
determining an actual value of the relative position from an electric voltage applied to an induction coil and determined by an appropriate measurement method and from an electric current flowing through the induction coil and also determined by an appropriate measurement method;
comparing the actual value of the relative position so determined is compared with a predetermined nominal value of the relative position;
adapting at least one of the voltage applied to the induction coil and the electric current flowing through the induction coil as a function of a difference between the actual value and the nominal value of the relative position to bring the actual value of the relative position closer to the nominal value of the relative position.

20. The method according to claim 19, further comprising the step calculating an actual value of at least one of the magnetic flux and the magnetic force from the voltage applied across the induction coil and from the current flowing through the induction coil and from this the actual value of the relative position is determined as a function of a characteristic performance curve.
